(19) United States
(12) Patent Application Publication
(10) Pub. No.: US 2018/0102835 A1
(43) Pub. Date: Apr. 12, 2018

(54) TRANSMISSION DEVICE AND NETWORK SYSTEM

(71) Applicant: FUJITSU LIMITED, Kawasaki-shi (JP)

(72) Inventors: Yuta Sekiya, Kawasaki (JP); Hiroyuki Fujii, Kawasaki (JP); Seiji Iwamoto, Sagamihara (JP); Yuichiro Hamano, Kawasaki (JP); Kazushige Saito, Yokohama (JP)

(73) Assignee: FUJITSU LIMITED, Kawasaki-shi (JP)

(21) Appl. No.: 15/716,759

(22) Filed: Sep. 27, 2017

(30) Foreign Application Priority Data
Oct. 12, 2016 (JP) 2016-201030

(51) Int. Cl. H04B 10/032; H04B 10/079; H04Q 11/00

(52) U.S. Cl. CPC H04B 10/032; H04B 10/0793; G08C 23/06; H04B 10/07953; H04Q 2011/0083; H04Q 11/0066

(57) ABSTRACT

A network system includes: a plurality of transmission devices configured to be coupled to each other via a first network; and a control monitor configured to be coupled to each of the plurality of transmission devices via a second network, wherein a first transmission device including a first transmitter, among the plurality of transmission devices includes a first processor configured to search for a signal area that is empty for checking connectivity in the first network, and transmit, by using the first transmitter, log information to a second transmission device including a second transmitter and a second processor among the plurality of transmission devices via the signal area in the first network when abnormality is detected in communication with the control monitor, and the second processor is configured to transmit, by using the second transmitter, the transmitted log information to the control monitor via the second network.

### CROSS-REFERENCE TO RELATED APPLICATION

This application is based upon and claims the benefit of priority of the prior Japanese Patent Application No. 2016-201030, filed on Oct. 12, 2016, the entire contents of which are incorporated herein by reference.

### FIELD

The embodiments discussed herein are related to a transmission device and a network system.

### BACKGROUND

FIG. 27 is a diagram illustrating a connection configuration of an optical transport network (OTN).

The optical transport network is a communication network system conforming to a communication standard (ITU-T Recommendation G.709) defined by international standardization organization ITU-T.

A network system 500 illustrated in FIG. 27 includes a network control monitor (operation system: OPS) 501 and a plurality of transmission devices 502.

The plurality of transmission devices 502 are connected to each other so as to communicate with each other via an OTN 510. The OTN 510 constitutes a main signal route which transmits a main signal. Hereinafter, there is a case where the OTN 510 is referred to as a main signal route 510.

In addition, each of the transmission devices 502 is connected to the OPS 501 via a control monitoring network 520. Hereinafter, there is a case where the control monitoring network 520 is referred to as a notification route 520.

In the optical transport network, the main signal route 510 connecting between the transmission devices 502 is dualized, and is configured so that information such as a warning desirable for operation can also be shared by the plurality of transmission devices 502 using the main signal route 510.

For this reason, even if the control monitoring network 520 between some of the transmission devices 502 and the OPS 501 is disconnected, a service can be continued.

Japanese Laid-open Patent Publication No. 2013-106153 and Japanese Laid-open Patent Publication No. 2012-015966 are examples of the related art.

However, as described above, since the service can be continued even if the control monitoring network 520 between some of the transmission devices 502 and the OPS 501 is disconnected, the notification route 520 to the OPS 501 is configured to be relatively inexpensive as compared with the main signal route 510. Accordingly, the control monitoring network 520 has a high risk of disconnection. When the disconnection occurs in a route between an interface unit in the transmission device 502 and the OPS 501, the control monitoring network 520 may not remotely obtain a device log and the like used for analysis of a failure factor, and there may be a case where a maintenance worker is dispatched.

### SUMMARY

According to an aspect of the embodiments, a network system includes: a plurality of transmission devices configured to be coupled to each other via a first network; and a control monitor configured to be coupled to each of the plurality of transmission devices via a second network, wherein a first transmission device including a first transmitter, among the plurality of transmission devices includes a first processor configured to search for a signal area that is empty for checking connectivity in the first network, and transmit, by using the first transmitter, log information to a second transmission device including a second transmitter and a second processor among the plurality of transmission devices via the signal area in the first network when abnormality is detected in communication with the control monitor, and the second processor is configured to transmit, by using the second transmitter, the transmitted log information to the control monitor via the second network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a configuration of a transmission system as an example of an embodiment;

FIG. 2 is a diagram illustrating a configuration of TCM;

FIG. 3 is a diagram illustrating a connectivity check method using TCM;

FIG. 4 is a diagram illustrating a hardware configuration of a transmission device in a transmission system as an example of the embodiment;

FIG. 5 is a diagram illustrating a functional configuration of the transmission device in the transmission system as an example of the embodiment;

FIG. 6 is a diagram for explaining a function realized by a device management section in the transmission system as an example of the embodiment;

FIG. 7 is a diagram for explaining a monitoring function of OTN in the transmission system as an example of the embodiment;

FIG. 8 is a diagram for explaining a method of transmitting a proxy notification availability inquiry message by a proxy node searching section in the transmission system as an example of the embodiment;

FIG. 9 is a diagram for explaining a response method of a proxy-available notification message from a proxy node in the transmission system as an example of the embodiment;

FIG. 10 is a diagram illustrating transmission of a device log from a failure node to a proxy node in the transmission system as an example of the embodiment;

FIG. 11 is a diagram illustrating a response to device log transmission from a proxy node to a failure node in the transmission system as an example of the embodiment;

FIG. 12 is a sequence diagram illustrating a transmission method of a device log from a failure node to a proxy node in the transmission system as an example of the embodiment;

FIG. 13 is a diagram illustrating a state in which conflict occurs in a device log transmission TCM in the transmission system as an example of the embodiment;

FIG. 14 is a diagram illustrating a TTI format;

FIG. 15 is a diagram illustrating a message format in the transmission system as an example of the embodiment;

FIG. 16 is a diagram illustrating correspondence relation between a message and a message ID in the transmission system as an example of the embodiment;

FIG. 17 is a flowchart illustrating a process in a failure node in the transmission system as an example of the embodiment;

FIG. 18 is a flowchart illustrating a process in a proxy node in the transmission system as an example of the embodiment;

FIG. 19 is an explanatory diagram of a process in which a failure node transmits a device log to a proxy node adjacent to the failure node in the transmission system as an example of the embodiment;

FIG. 20 is a sequence diagram for explaining a process of a failure node in a case where the failure node transmits a device log to a proxy node adjacent to the failure node in the transmission system as an example of the embodiment;

FIG. 21 is a sequence diagram for explaining a process of a proxy node in a case where a failure node transmits a device log to the proxy node adjacent to the failure node in the transmission system as an example of the embodiment;

FIG. 22 is an image diagram of a process in a case where a node adjacent to a failure node may not become a proxy node in the transmission system as an example of the embodiment;

FIG. 23 is a sequence diagram illustrating a process of a proxy-unavailable node in the transmission system as an example of the embodiment;

FIG. 24 is an image diagram of a process in which an interruption occurs during a device log is transmitted from a failure node to a proxy node in the transmission system as an example of the embodiment;

FIG. 25 is a sequence diagram illustrating a process of a failure node in a case where an interruption occurs during transmission of a device log in the transmission system as an example of the embodiment;

FIG. 26 is a sequence diagram illustrating a process of a proxy node in a case where an interruption occurs during transmission of a device log in the transmission system as an example of the embodiment; and

FIG. 27 is a diagram illustrating a connection configuration of an optical transport network.

### DESCRIPTION OF EMBODIMENTS

Hereinafter, an embodiment according to a transmission device, a program, and a network system will be described with reference to drawings. However, the following embodiments are merely examples, and there is no intention to exclude application of various modifications and techniques not explicitly described in the embodiments. That is, the present embodiment can be implemented with various modifications (a combination of the embodiment and each of the modifications) without departing from spirit of the present embodiment. In addition, each of the drawing is not intended to include only components illustrated in the drawing, but can include other functions.

A. Configuration

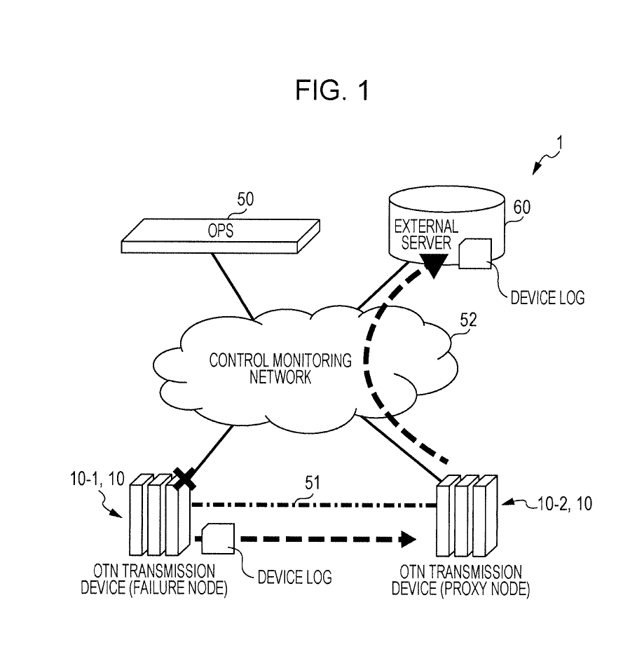

FIG. 1 is a schematic diagram illustrating a configuration of a transmission system 1 as an example of the embodiment.

The transmission system 1 illustrated in FIG. 1 is OTN, and includes an OPS 50, an external server 60, and a plurality (two in an example illustrated in FIG. 1) of transmission devices 10-1 and 10-2.

Hereinafter, as reference numerals indicating the transmission device, reference numerals 10-1 and 10-2 are used when it is desirable to specify one of the plurality of the transmission devices, but reference numeral 10 is used when indicating an arbitrary transmission device. In addition, hereinafter, there is a case where the transmission device 10 is referred to as a node 10.

An OTN 51 is a ring-type network constituting a main signal route which transmits a main signal. Hereinafter, there is a case where the OTN 51 is referred to as a main signal route 51.

In an optical transport network (OTN), as a signal quality monitoring method of a communication path, a trail trace identifier (TTI) is used to check connectivity with each other. As a function for realizing a connectivity check, three types of monitoring methods using signal areas of section monitoring (SM), path monitoring (PM) and tandem connection monitoring (TCM) are known.

A signal area is an area used for checking connectivity between two nodes. In the present example, the signal area is an area used for checking connectivity between two arbitrarily settable nodes. For example, in the signal area, a check value used for checking connectivity is stored and misconnection or the like is determined (connectivity is checked) on a reception side by comparing the check value with an expected value.

For example, TCM is used by a network administrator setting a connectivity check between arbitrary nodes via OPS. In the related OTN, a use frequency of TCM is low.

As described above, TCM is used for checking connectivity between arbitrary nodes by the network administrator. A 64-byte TTI area is used for a connectivity check.

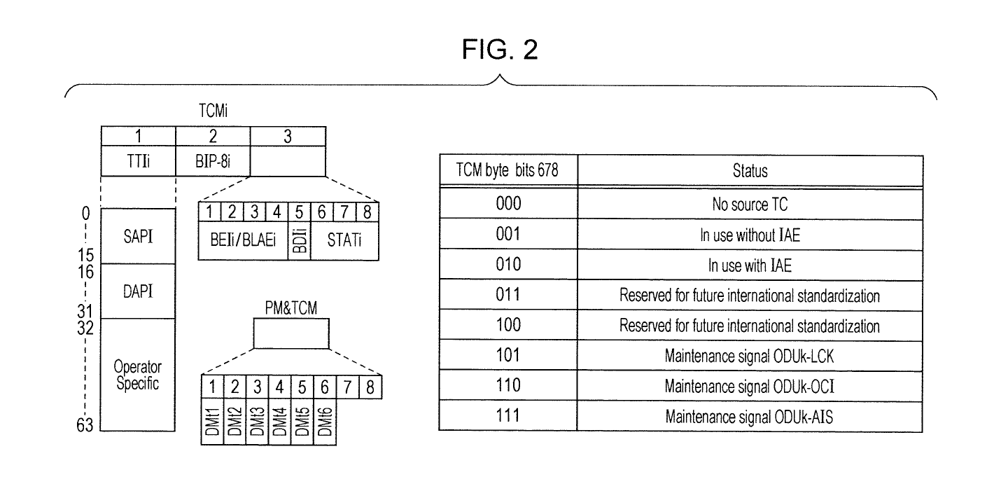

FIG. 2 is a diagram illustrating a configuration of TCM. The configuration of TCM illustrated in FIG. 2 is defined in ITU-T G.709.

In OTN, six of TCMs 1 to 6 are prepared, and the TCMs 1 to 6 can be used within a range which does not overlap between sections. A value set in a TTI area of a frame is monitored at a point of terminating TCM. If the value is different from an expected value, misconnection is determined and a TTI Mismatch warning is issued. In a case of terminating the TCM, a predetermined value (001 or 010) indicating that the TCM is in use is set to a 3-bit status (STAT) area.

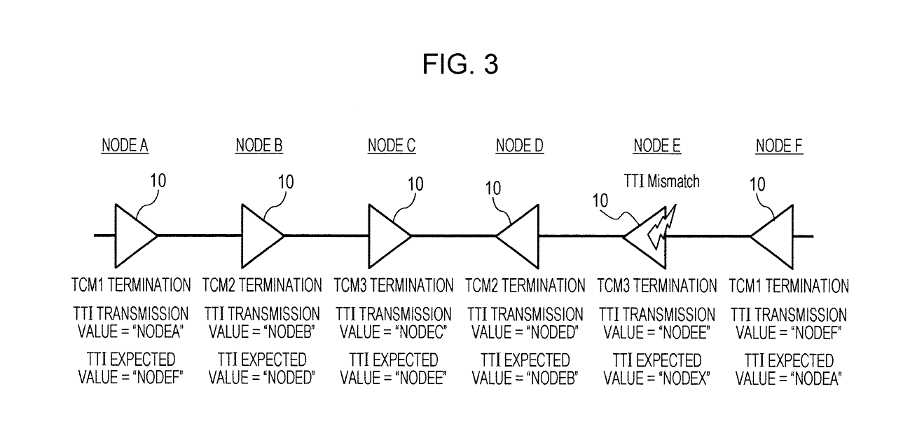

FIG. 3 is a diagram illustrating a connectivity check method using TCM. In the example illustrated in FIG. 3, TCM 1 is terminated at a node A and a character string of “NODEA” is inserted into TTI. In the same manner, the TCM 1 is terminated at a node F and “NODEA” is set to a reception-expected value of the TTI, and thus it can be checked that a signal from the node A is normally received. TCM 3 is terminated at a node E and a reception value of TTI of the TCM 3 is “NODEC”, but an expected value is set to “NODEX”. By warning a TTI Mismatch, it is notified that a connectivity check is NG to a network administrator.

The OPS 50 is a control monitor which manages the transmission system 1. The external server 60 is an information processing device having a server function.

Each of the transmission devices 10 is coupled to the OPS 50 via a control monitoring network 52. Hereinafter, there is a case where the control monitoring network 52 is referred to as a notification route 52.

Each of the transmission devices 10 transmits log data of the device (log information) to the external server 60 via the OPS 50. Hereinafter, there is a case where the log data of the device is referred to as device log data. Further, there is also a case where the log data of the device is simply referred to as a device log. In the transmission system 1, a device log of the transmission device 10 is stored in a storage device (not illustrated) of the external server 60 and is used for error analysis or the like.

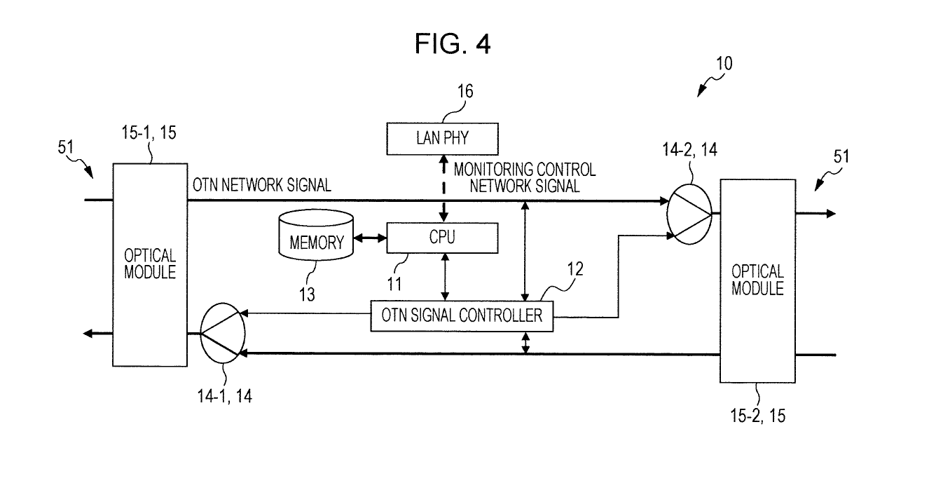

FIG. 4 is a diagram illustrating a hardware configuration of the transmission device 10 in the transmission system 1 as an example of the embodiment.

As illustrated in FIG. 4, the transmission device 10 includes a CPU 11, an OTN signal controller 12, a memory 13, termination control switches (SW) 14-1 and 14-2, optical modules 15-1 and 15-2, and a local area network (LAN) physical layer (PHY) 16.

The LAN PHY 16 is a chip (electronic device) which performs a process related to an Ethernet (trademark) physical layer, and performs communication control with the control monitoring network 52. A control monitoring network signal is transmitted or received between the transmission device 10 and the OPS 50 via the control monitoring network 52. The LAN PHY 16 is also called as a transmitter and a receiver.

The optical modules 15-1 and 15-2 exchanges an optical signal and an electric signal with each other. The optical modules 15-1 and 15-2 converts an optical signal (OTN signal) flowing through the OTN 51 into an electric signal or converts the electric signal into the optical signal. The optical modules 15-1 and 15-2 is also called as an optical transmitter and an optical receiver.

The transmission device 10 is disposed so as to relay an optical signal on a transmission line of the OTN 51. A west side of the transmission device 10 is coupled to the OTN 51 via the optical module 15-1. In addition, an east side of the transmission device 10 is coupled to the OTN 51 via the optical module 15-2.

The memory 13 is a storage device including a read only memory (ROM) and a random access memory (RAM). A software program (firmware) related to transmission control and data for this program are written in the ROM of the memory 13. The software program on the memory 13 is read and executed as appropriate by the CPU 11. Further, the RAM of the memory 13 is used as a primary storage memory or a working memory. A temporary device log is also stored in the RAM of the memory 13.

The termination control switches 14-1 and 14-2 switch whether to pass or to receive a frame in the OTN 51. By switching the termination control switches 14-1 and 14-2 for termination, it is possible to receive a frame flowing through the OTN 51 into the own transmission device 10 or to flow the frame from the own transmission device 10 to the OTN 51.

The CPU 11 described below controls the termination control switches 14-1 and 14-2 to be switched.

The OTN signal controller 12 obtains a frame flowing through the OTN 51 or transmits the frame to the OTN 51.

The CPU 11 is a processing device (hardware processor) which performs various types of control and calculation, and performs various functions by executing the firmware stored in the ROM 13 or the like of the memory 13.

The CPU 11 controls or monitors an OTN signal flowing through the OTN 51 via the OTN signal controller 12.

In addition, the CPU 11 transmits or receives a control monitoring network signal flowing through the control monitoring network 52 via the LAN PHY 16.

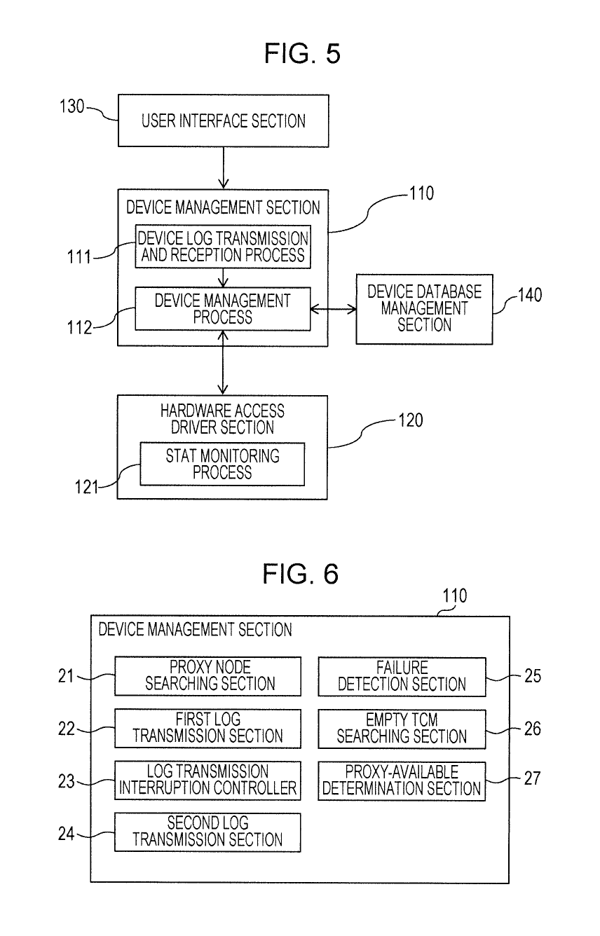

FIG. 5 is a diagram illustrating a functional configuration of the transmission device 10 in the transmission system 1 as an example of the embodiment.

As illustrated in FIG. 5, the CPU 11 realizes functions as a user interface section 130, a device management section 110, a hardware access driver section 120, and a device database management section 140.

A program (firmware) for realizing the function as the user interface section 130, the device management section 110, the hardware access driver section 120, and the device database management section 140 is provided to be recorded on a computer readable recording medium, for example, a floppy disk, a CD (a CD-ROM, a CD-R, a CD-RW, or the like), a DVD (a DVD-ROM, a DVD-RAM, a DVD-R, a DVD+R, a DVD-RW, a DVD+RW, an HD DVD, or the like), a Blu-ray disc, a magnetic disc, an optical disc, and a magneto-optical disc. The computer reads the program from the recording medium, transmits and stores the program to an internal storage device or an external storage device, and uses the program. In addition, it is also possible to record the program on a storage device (recording medium) such as a magnetic disk, an optical disk, or a magneto-optical disk, and to provide the program from the storage device to the computer via a communication path.

When executing the function as the user interface section 130, the device management section 110, the hardware access driver section 120, and the device database management section 140, the program stored in the internal storage device (RAM or ROM in the memory 13 in the present embodiment) is executed by a microprocessor (the CPU 11 in the present embodiment) of the computer. At this time, the computer may read the program recorded on the recording medium and may execute the program.

The user interface section 130 provides a user interface for an operator to perform an operation input. For example, a menu screen or the like is displayed on a display device (not illustrated).

The hardware access driver 120 performs a process of accessing to the OTN 51. The hardware access driver 120 realize, for example, a STAT monitoring process 121. During the first log transmission section 22 described below transmits a log to a proxy node 10, the STAT monitoring process 121 continues to monitor STAT of TCM used for transmission of the log. The STAT monitoring process 121 is an interrupt handler. When TCM of a monitoring target is used by another node 10, that is, when detecting TCM (device log transmission TCM) in use for log transmission to be used by another transmission device 10, the STAT monitoring process 121 inputs an interruption (notifies log transmission interruption) to the device management process 112. In this way, the STAT monitoring process 121 functions as a monitoring section which monitors a use state of the TCM (signal area).

The fact that the TCM of the monitoring target is used by another node 10 is notified by the TCM inputting a use interruption to the STAT monitoring process 121.

The device database management section 140 stores and manages various types of information in the transmission device 10.

The device management section 110 performs management related to the transmission device 10 (hereinafter, referred to as “own transmission device 10” or “own node 10”) which the device management section 110 functions.

The device management section 110 executes a device log transmission and reception process 111 and the device management process 112.

The device log transmission and reception process 111 transmits and receives messages between the nodes 10. For example, in a case where the own node 10 fails, the device log transmission and reception process 111 exchanges messages between the failed own node 10 and the proxy node 10. Hereinafter, there is a case where the failed transmission device 10 is referred to as a failure node 10. Further, failure in the present embodiment means, for example, a state in which an abnormality occurs in an interface section such as the LAN PHY 16 and communication with the OPS 50 is disabled.

In addition, in a case where the own node 10 functions as the proxy node 10, the device log transmission and reception process 111 exchanges messages between the failed node 10 and the own node 10.

The device management process 112 manages a process of the transmission device 10 when failure occurs in the transmission system 1.

FIG. 6 is a diagram for explaining a function realized by the device management section 110 in the transmission system 1 as an example of the embodiment.

As illustrated in FIG. 6, the device management section 110 realizes functions as a proxy node searching section 21, the first log transmission section 22, a log transmission interruption controller 23, a second log transmission section 24, a failure detection section 25, an empty TCM searching section 26, and a proxy-available determination section 27.

Among these functions, each of the functions as the proxy node searching section 21, the first log transmission section 22, the log transmission interruption controller 23, and the empty TCM searching section 26 is realized by the transmission device 10 in which failure of the own node 10 is detected by the failure detection section 25. Also, there is a case where the transmission device 10 in which failure of the own node 10 is detected is referred to as a failure node 10.

In addition, as described below, each of functions as the proxy-available determination section 27, the log transmission interruption controller 23, and the second log transmission section 24 is desirable to be realized by the proxy node 10 which transmits log data of the device of the failure node 10 to the OPS 50 instead of the failure node 10.

Each of functions as the first log transmission section 22, the log transmission interruption controller 23, and the second log transmission section 24 is realized by the device log transmission and reception process 111. In addition, each of functions as the proxy node searching section 21, the failure detection section 25, the empty TCM searching section 26, and the proxy-available determination section 27 is realized by the device management process 112.

The failure detection section 25 detects occurrence of failure in the own node 10. Specifically, the failure detection section 25 detects occurrence of communication failure with the OPS 50. For example, the failure detection section 25 detects failure of the LAN PHY 16 or failure in a connection cable or an interface section with the control monitoring network 52. The failure detection section 25 can detect failure by various methods, and details of the methods will be omitted.

The empty TCM searching section (empty signal area searching section) 26 searches for an empty TCM in the OTN 51, that is, a TCM area (empty signal area) not used for data transmission.

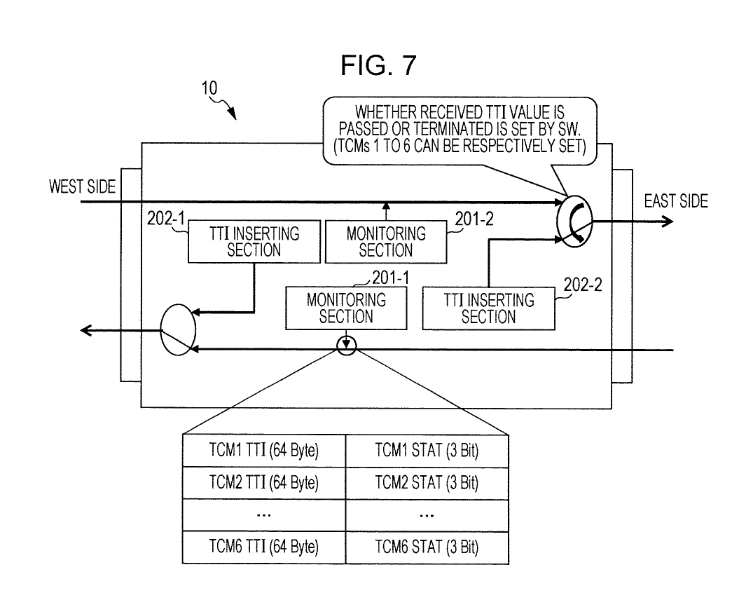

FIG. 7 is a diagram for explaining a monitoring function of the OTN 51 in the transmission system 1 as an example of the embodiment.

As illustrated in FIG. 7, the transmission device 10 includes monitoring sections 201-1 and 201-2 and TTI inserting sections 202-1 and 202-2.

The monitoring section 201-1 monitors a frame flowing on a west side of the transmission device 10 in the OTN 51. Specifically, the monitoring section 201-1 monitors a frame flowing during a period assigned to the TCMs 1 to 6 on a west side of the OTN 51 and respectively monitors a TTI area (64-byte) and an STAT area (3-bits) of the frame.

On the other hand, the monitoring section 201-2 monitors a frame flowing on an east side of the transmission device 10 in the OTN 51. Specifically, the monitoring section 201-2 monitors a frame flowing through the TCMs 1 to 6 on an east side of the OTN 51 and respectively monitors a TTI area (64-byte) and an STAT area (3-bits) of the frame.

Hereinafter, as reference numerals indicating the monitoring section, reference numerals 201-1 and 201-2 are used when it is desirable to specify one of the plurality of the monitoring sections, but reference numeral 201 is used when indicating an arbitrary monitoring section.

The TTI inserting sections 202-1 and 202-2 insert TTI into a frame flowing through the OTN 51. Specifically, the TTI inserting section 202-1 inputs a character string for identifying the own node 10 into the TTI area of the frame flowing through the TCMs 1 to 6 on the west side of the OTN 51, and thus terminates the TCM through which the inserted frame flows. In the same manner, the TTI inserting section 202-2 inputs a character string for identifying the own node 10 into the TTI area of the frame flowing through the TCMs 1 to 6 on the east side of the OTN 51, and thus terminates the TCM through which the inserted frame flows.

Hereinafter, as reference numerals indicating the TTI inserting section, reference numerals 202-1 and 202-2 are used when it is desirable to specify one of the plurality of the TTI inserting sections, but reference numeral 202 is used when indicating an arbitrary TTI inserting section. In addition, hereinafter, there is a case where inputting the character string to the TTI area of the frame flowing through the TCMs 1 to 6 to identify the own node 10 may be referred to as inserting a TTI.

The empty TCM searching section 26 searches for an empty TCM area from the TCMs 1 to 6 on the west side of the OTN 51 and the TCMs 1 to 6 on the east side of the OTN 51. Whether or not a TCM area is empty is determined based on whether or not the TCM of a determination target satisfies all of following conditions (1) to (3). That is, in a case where the TCM of the determination target satisfies all of the following conditions (1) to (3), the empty TCM searching section 26 determines that the TCM area is in an empty state.

Condition (1): TCM of a determination target is not set to be terminated at the own node 10 by the OPS 50. That is, TTI is not inserted.

Condition (2): the TCM is not used by another node 10. That is, an STAT area detected by the monitoring section 201 is not “001” or “010”.

Condition (3): the TCM of the determination target is not already used for log transmission by the first log transmission section 22 described below. When the condition (3) is satisfied, since the TCMs used for log transmission do not overlap, log transmission does not conflict with each other.

Hereinafter, there is a case where the TCM of an empty state not used is referred to as “an empty TCM”.

When detecting an empty TCM, the empty TCM searching section 26 sets the empty TCM to be terminated by inserting the TTI by the TTI inserting section 202.

The proxy-available determination section 27 determines (performs a proxy-available determination function) whether or not the own node 10 can be the proxy node 10.

Here, the proxy node 10 is the transmission device 10 which transmits a device log of the failure node 10 to the OPS 50 instead of the failure node 10. For example, in a case where the own node 10 is normally coupled to the OPS 50, the proxy-available determination section 27 determines that the own node 10 can be the proxy node 10. Whether or not the own node 10 can be the proxy node 10 is not only determined by this, but can be determined by another appropriately changed determination reference. For example, a load (processor load or traffic load) and the like in the own node 10 may be considered. That is, in a case where a value indicating a load state of the own node 10 is equal to or smaller than a reference value, even if the own node 10 is normally coupled to the OPS 50, it may be determined the own node 10 may not be the proxy node 10 or can be determined by another appropriately changed determination reference.

Proxy Node Searching Section

For example, in each of the transmission devices 10, a network administrator sets a route (notification route) for transmitting a device log of the own node 10 to the external server 60 in advance via the OPS 50. However, in a case where the own node 10 fails, the device log may not be transmitted from the own node 10 to the external server 60.

In the failure node 10, the proxy node searching section 21 searches for the proxy node 10 which transmits the device log of the own node 10 to the external server 60 instead of the failure own node 10.

By transmitting a proxy notification availability inquiry message to other nodes 10 using an empty TCM searched by the empty TCM searching section 26, the proxy node searching section 21 searches for the proxy node 10.

The proxy node searching section 21 causes the TTI inserting section 202 to insert the proxy notification availability inquiry message to a TTI area of a frame of the empty TCM.

Hereinafter, transmitting the frame in which the proxy notification availability inquiry message is set to the TTI area, to TCM is referred to as transmitting a proxy notification availability inquiry message.

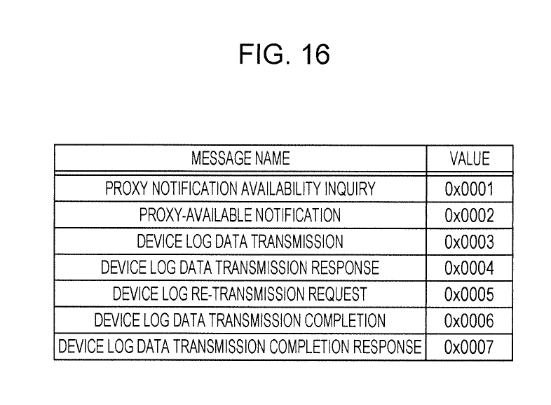

A format of this proxy notification availability inquiry message will be described below with reference to FIGS. 15 and 16.

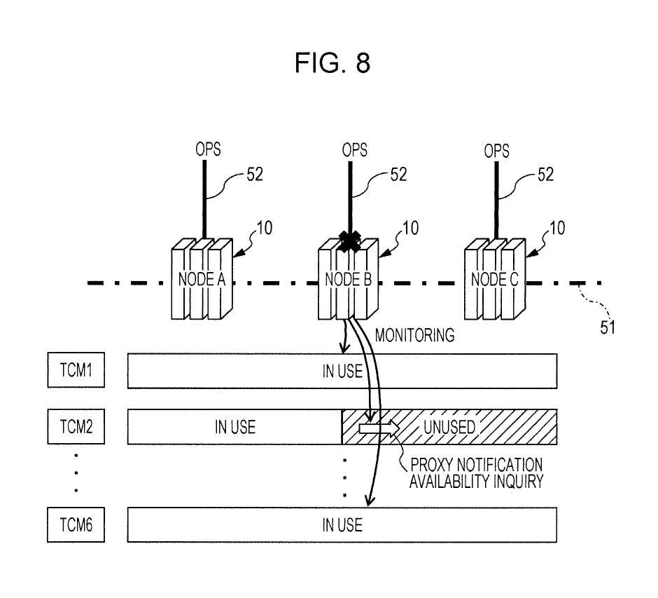

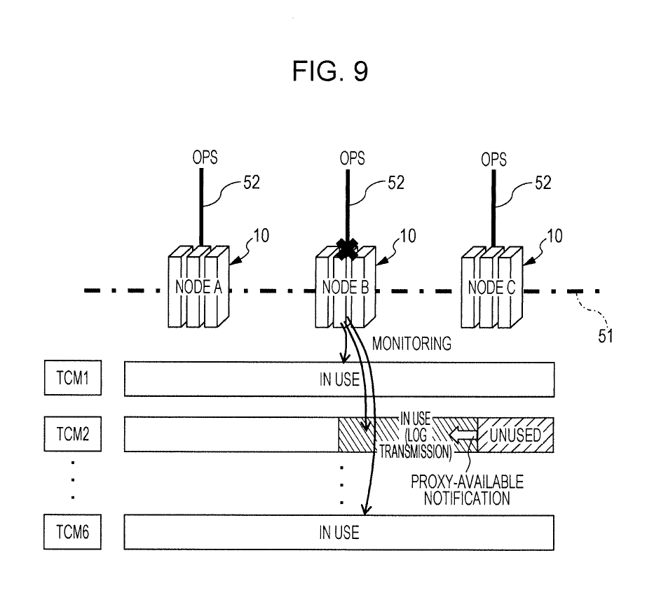

FIG. 8 is a diagram for explaining a method of transmitting a proxy notification availability inquiry message by the proxy node searching section 21 in the transmission system 1 as an example of the embodiment. FIG. 9 is a diagram for explaining a response method of a proxy-available notification message from the proxy node 10.

In an example illustrated in FIG. 8, a node B is the failure node 10, a state in which a communication path is decoupled to the OPS 50, and a proxy notification availability inquiry message is transmitted to an east side.

The empty TCM searching section 26 monitors a use state of the TCMs 1 to 6 and detects that the east side of the TCM 2 is not used. The proxy node searching section 21 notifies the east side of the TCM 2, which is in an empty state, of a proxy notification availability inquiry message.

The transmission device 10 determined to be proxy-available by the own node 10 sets the TCM2 to be terminated according to the proxy notification availability inquiry message from the failure node 10. That is, the TTI inserting section 202 inserts a proxy-available notification message indicating that proxy is possible, into a TTI area of a frame of the TCM 2.

In an example illustrated in FIG. 9, a proxy-available notification message indicating that a node C is proxy-available is notified in response to the proxy notification availability inquiry message from the node B.

On the other hand, the transmission device 10, which is not coupled to the OPS 50 or does not communicate with the OPS 50, does not terminate a proxy notification availability inquiry message flowing through the TCM2 and passes the proxy notification availability inquiry message. Further, as a necessity, a node to which the embodiment is not applied also passes the proxy notification availability inquiry message. A format of the proxy-available notification message will be described below with reference to FIGS. 15 and 16.

Hereinafter, transmitting the frame in which the proxy-available notification message is set to the TTI area, to TCM is referred to as transmitting a proxy-available notification message.

In a case where the proxy-available notification message is not received from any of the transmission devices 10 even after a certain time elapses after inserting the proxy notification availability inquiry message into the frame of the empty TCM, the proxy node searching section 21 releases termination setting of the empty TCM. That is, the proxy node searching section 21 causes the TTI inserting section 202 to release insertion of the proxy notification availability inquiry message. The proxy node searching section 21 searches for the empty TCM by the empty TCM searching section 26 and notifies the proxy notification availability inquiry message again (retries searching and notification).

For example, a process, in which the proxy node searching section 21 retries searching the empty TCM and transmission of the proxy notification availability inquiry message, is performed at the maximum of 12 {=6 (TCMs 1 to 6)×2 (west side and east side)} times.

In a case where the proxy-available notification message is not received from any of the node 10 even after the proxy node searching section 21 executes the process 12 times, proxy transmitting of a device log from the proxy node 10 to the external server 60 is not performed and the process is ended.

First Log Transmission Section

In the failure node 10, the first log transmission section 22 transmits (transports) a device log to the proxy node 10 determined by the proxy node searching section 21 (a device log transmission process to the proxy node 10).

The failure node 10 starts to transmit the device log stored in the memory 13 of the own node 10 to the proxy node 10 according to reception of a proxy-available notification message.

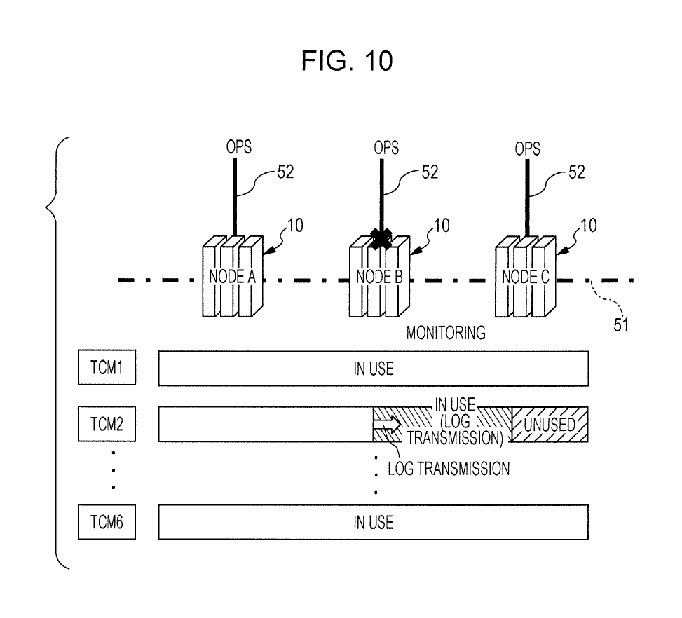

The failure node 10 inserts a device log data transmission message into the empty TCM to transmit the device log. The first log transmission section 22 adds device log data to the device log data transmission message. FIG. 10 is a diagram illustrating transmission of a device log from the failure node 10 to the proxy node 10 in the transmission system 1 as an example of the embodiment.

In an example illustrated in FIG. 10, the node B, which is the failure node 10, transmits a device log to the node C, which is the proxy node 10, using TCM 2.

After receiving the device log data transmission message from the failure node 10, the proxy node 10 holds log data of the device stored inside the message in the memory 13 and inserts a device log data transmission response message into the TCM.

The first log transmission section 22 repeats insertion or transmission of the device log data transmission message or the device log data transmission response message depending on a size of the device log.

In addition, the first log transmission section 22 adds a checksum value to the device log data transmission message.

The proxy node 10 checks the checksum value of the received device log data. In a case where the checksum value is abnormal, the proxy node 10 inserts a device log re-transmission request message instead of the device log data transmission response message to response to the failure node 10. A format of the message will be described below with reference to FIGS. 15 and 16.

When transmission of the device log to the proxy node 10 is completed, the first log transmission section 22 in the failure node 10 causes the TTI inserting section 202 to insert a device log data transmission completion message into the TTI.

The proxy node 10 performs file conversion on the device log according to reception of the device log data transmission completion message. In addition, the proxy node 10 causes the TTI inserting section 202 to insert a device log data transmission completion response message into the TTI. The failure node 10 and the proxy node 10 releases termination setting of the TCM used for transmitting any of the device log according to the device log data transmission completion response message.

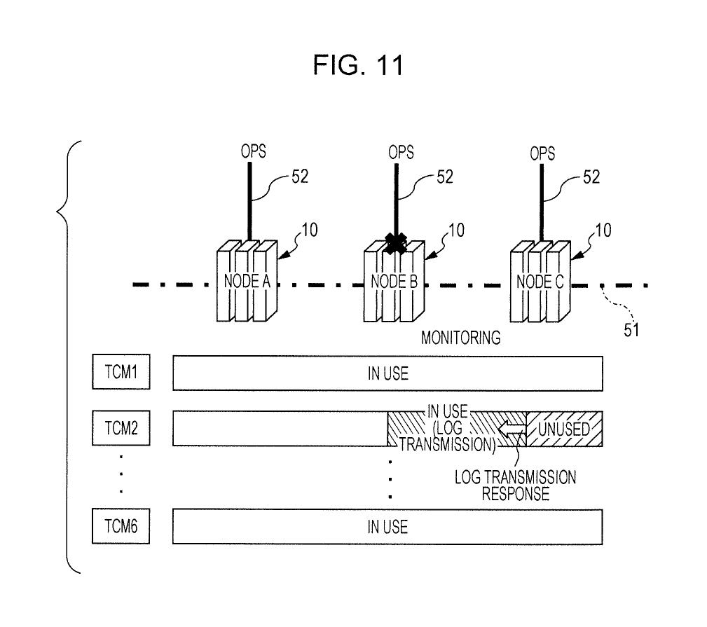

FIG. 11 is a diagram illustrating a response to a device log transmission from the proxy node 10 to the failure node 10 in the transmission system 1 as an example of the embodiment.

In an example illustrated in FIG. 11, the node C, which is the proxy node 10, responses to a device log transmission to the node B, which is the failure node 10, using TCM 2.

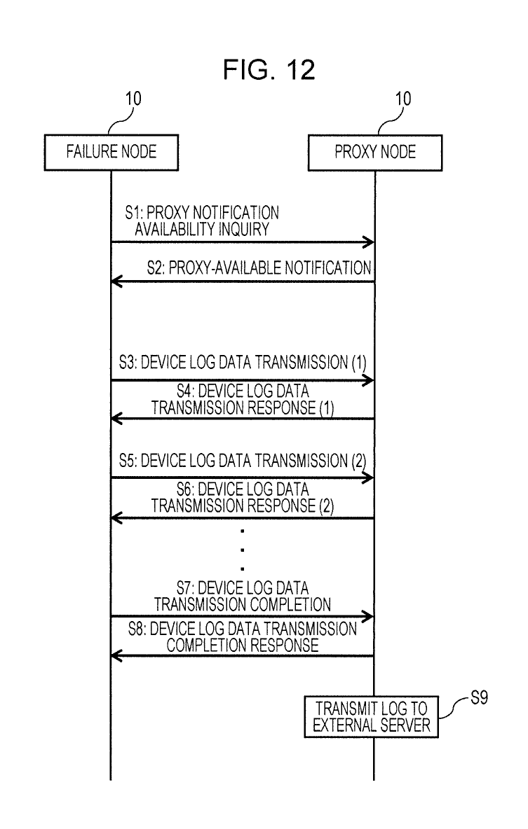

FIG. 12 is a sequence diagram illustrating a transmission method of a device log from the failure node 10 to the proxy node 10 in the transmission system 1 as an example of the embodiment.

It is desirable to set timeout for message exchange. At timeout, termination setting of TCM is released and the log transmission process is stopped.

As illustrated in FIG. 12, the proxy notification availability inquiry message is transmitted from the proxy node searching section 21 to each of the nodes 10 (see symbol S1). In a case where it is determined that the proxy-available determination section 27 is proxy-available, the proxy node 10 responses with the proxy-available notification message to the failure node 10 (see symbol S2).

Hereinafter, the first log transmission section 22 of the failure node 10 does not transmit a device log to the proxy node 10 (see symbols S3 and S5), the proxy node 10 perform a device log data transmission response (see symbols S4 and S6). The device log transmission and the device log data transmission response are repeated until transmission of the device log is completed. Hereinafter, there is a case where TCM used for transmission of the device log data from the failure node 10 to the proxy node 10 is referred to as a device log transmission TCM.

When transmission of the device log is completed, the first log transmission section 22 notifies the proxy node 10 of device log data transmission completion (see symbol S7), and the proxy node 10 transmits a device log data transmission completion response (see symbol S8).

The second log transmission section 24 of the proxy node 10 transmits the device log data received from the failure node 10 to the external server 60 (see symbol S9), and the process is ended.

Log Transmission Interruption Controller

In the failure node 10 and the proxy node 10, in a case where a use setting of TCM (signal area) used for transmission is performed by the OPS 50 during a process of transmitting a log from the failure node 10 to the proxy node 10, the log transmission interruption controller 23 immediately interrupts transmission of the device log data (log transmission process interruption).

For example, the log transmission interruption controller 23 transmits a log transmission interruption notification to the device log transmission and reception process 111 (first log transmission section 22).

In a case where the OPS 50 sets the device log transmission TCM to be used during the process of transmitting the device log to the proxy node 10, since the TCM is terminated between the nodes 10 which transmit the device log, a transmission value of the TTI set by the OPS 50 does not match an expected value, and thus, a TTI mismatch occurs.

For this reason, in a case where the OPS 50 sets the device log transmission TCM to be used, the log transmission is desirable to be stopped quickly. In the failure node 10 and the proxy node 10, in a case where the OPS 50 performs termination setting of the device log transmission TCM, the log transmission interruption controller 23 stops the log transmission according to the setting.

For example, the log transmission interruption controller 23 stops to insert the log transmission message and inserts the character string set to the OPS 50 instead of the message.

On the other hand, in a case where the OPS 50 performs termination setting of the TCM on the node 10 outside the failure node 10 and the proxy node 10, there is no direct trigger on the failure node 10 and the proxy node 10, which are set to be terminated for the device log transmission.

For this reason, in order to determine whether or not the device log transmission TCM is used by OPS 50, the failure node 10 and the proxy node 10 continues to monitor the STAT area of the device log transmission TCM during the log transmission.

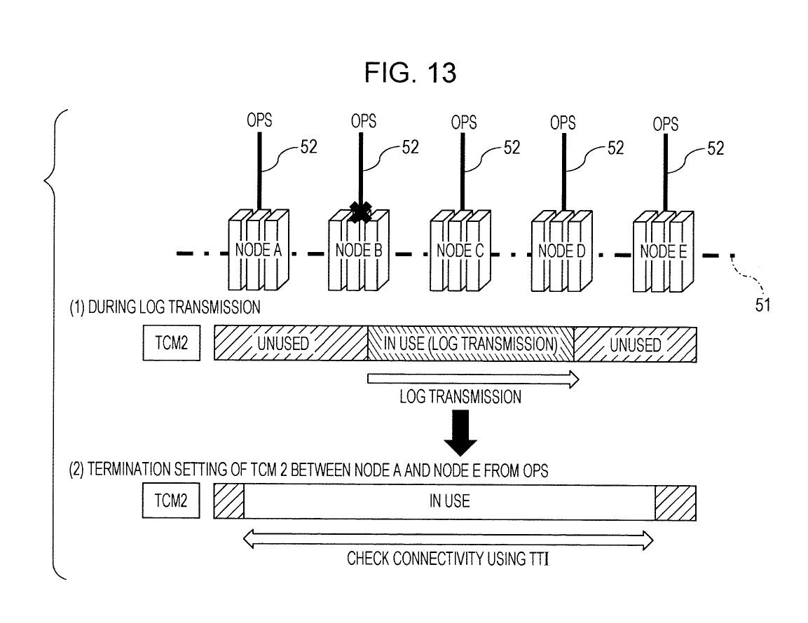

FIG. 13 is a diagram illustrating a state in which conflict occurs in a device log transmission TCM in the transmission system 1 as an example of the embodiment.

In an example illustrated in FIG. 13, a device log is transmitted from the node B to a node D using TCM 2. That is, the TCM 2 is a device log transmission TCM. (see symbol (1) in FIG. 13).

In such a state, as indicated by symbol (2), it is assumed that the TCM 2 is set to be used between the node A and a node E across the node B and the node D.

the node A and the node E respectively rewrite a use setting to an STAT area (001 or 010). When the STAT is changed to the use setting in the node B and the node D, the log transmission interruption controller 23 releases the termination setting of the TCM 2 and interrupts the log transmission process.

Accordingly, the OPS 50 can operate the TCM 2 between the node A and the node E. At this time, there is a risk of occurrence of TTI mismatch transitionally. However, even in a normal state (when the first log transmission section 22 does not transmit the device log), a timing of setting a TTI transmission value to the node A and a timing of setting a TTI expected value to the node E is not synchronized with each other, and thus, a transitional TTI mismatch is not a problem. Further, the TTI Mismatch warning lastly disappears.

Second Log Transmission Section

In the proxy node 10, the second log transmission section 24 transmits (transmits the device log to the external server 60) the device log of the failure node 10 to the external server 60 via the OPS 50 according to completion of device log transmission process from the failure node 10 (first log transmission section 22).

For example, the second log transmission section 24 performs file conversion on the device log received from the failure node 10 and transmits the file to the external server 60 via file transfer protocol (FTP) and the like.

About Message Format

The transmission system 1 transmits or receives messages between the nodes 10 using an operator specific area of TTI indicated by ITU-T G.709.

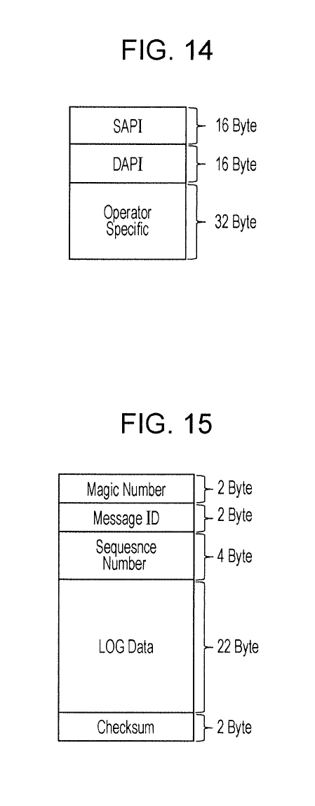

FIG. 14 is a diagram illustrating a TTI format and is defined by ITU-T G.709.

According to ITU-T G.709, By setting a source address to SAPI and setting a destination address to DAPI, the node 10, which receives a frame, can determine that the frame is a message transmitted from which node 10.

Since the proxy notification availability inquiry message to be transmitted by the proxy node searching section 21 is transmitted in a state in which it is not determined that which transmission device 10 becomes the proxy node 10, DAPI is transmitted by ALLO (that is, broadcast method).

FIG. 15 is a diagram illustrating a message format in the transmission system 1 as an example of the embodiment.

The message format illustrated in FIG. 15 includes a magic number, a message ID, a sequence number, log data, and a checksum.

A unique value indicating a message related to a device log transmission process of the failure node 10 in the transmission system 1 is set to the magic number. If the value is not a unique value, the value is treated as a normal TTI value. The magic number has, for example, a data size of 2 bytes.

An identification information (ID) indicating a message related to the device log transmission process of the failure node 10 in the transmission system 1 is set to the message ID. The message ID has, for example, a data size of 2 bytes.

FIG. 16 is a diagram illustrating correspondence relation between a message and a message ID in the transmission system 1 as an example of the embodiment.

For example, the proxy node searching section 21 of the failure node 10 sets the message ID to “0x0001”, so that a proxy notification availability inquiry message is generated. For example, the transmission device 10, which becomes the proxy node 10, sets the message ID to “0x0002”, so that a proxy-available notification message is generated.

When device log data is transmitted a plurality of times, the sequence number indicates a progress state of the transmission. That is, the sequence number indicates the number of the log data to be transmitted, the number of log data transmission success or failure, and the like.

The sequence number is set to “Don't care” in cases other than a case where the message ID is device log data transmission, device log data transmission response, and device log data re-transmission request. The sequence number has, for example, a data size of 4 bytes.

The log data of the device is set to the log data. The log data has a data size of 22 bytes, and the log can be transmitted up to 22 bytes at a time. In a case of transmitting device log data having a size equal to or larger than 22 bytes, the device log data is transmitted in a plurality of times. The log data is set to “Don't care” in cases other than a case where the message ID is device log data transmission (0x0003).

The checksum indicates a checksum value of an entire message. In a case where the checksum value is abnormal on a reception side, the process is not moved to the next process. In a case where an error continues to occur, the log transmission process is stopped by a timeout. The checksum has, for example, a data size of 2 bytes.

B. Operation

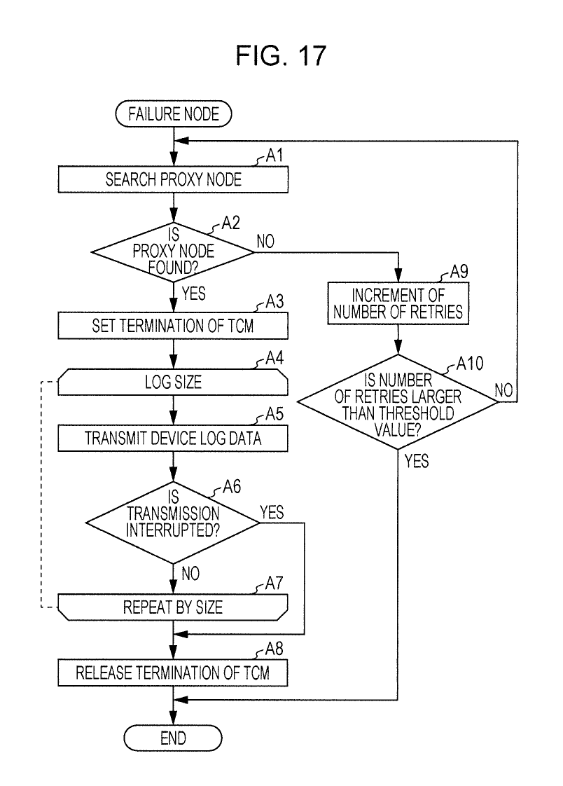

A process of the failure node 10 in the transmission system 1 as an example of the embodiment described above will be described according to a flowchart (steps A1 to A10) illustrated in FIG. 17.

In the node 10, when the failure detection section 25 detects occurrence of failure in the own node 10, the empty TCM searching section 26 searches for an empty TCM and the proxy node searching section 21 transmits a proxy notification availability inquiry message to the empty TCM by a broadcast method (step A1).

Whether or not any of other the nodes 10 transmits a proxy-available notification message, that is, whether or not the proxy node 10 is found is checked (step A2). As a result of checking, in a case where the proxy-available notification message is not transmitted (see NO route in step A2), the process is moved to step A9.

In step A9, the number of retries is increased, and in step A10, it is checked whether or not the number of retries is equal to or larger than a predetermined threshold value. In a case where the number of retries is smaller than the threshold value, that is, the number of retries is not over than the threshold value (see NO route in step A10), the process is returned to step A1.

In a case where the number of retries is equal to or larger than the threshold value, that is, the number of retries is over than the threshold value (see YES route in step A10), the process is ended.

In addition, a result of checking in step A2, in a case where another node 10 transmits the proxy-available notification message (see YES route in step A2), the termination control switches 14 are switched and termination setting of the empty TCM is performed (step A3). Accordingly, TCM, which is an empty TCM, becomes a device log transmission TCM.

In step A4, a loop process, in which the process repeatedly proceeds to step A7 for all of device logs (divided device log) divided into section sizes (for example, 22 bytes) until a size of the transmitted device log reaches a total log size, is started.

In step A5, the divided device log is transmitted. In step A6, it is checked whether or not the log transmission interruption controller 23 interrupts transmission.

In a case where transmission is not interrupted (see NO route in step A6), the process is moved to step A7.

In step A7, a loop end process corresponding to step A4 is executed. Here, when a total value of sizes of the divided transmission log data of the device reaches a size of the log data of the device, that is, when all of the divided device logs is completely transmitted, the process is moved to step A8.

In addition, as a result of checking in step A6, even in a case where the log transmission interruption controller 23 interrupts transmission of the device log (see YES route in step A6), the process is moved to step A8.

In step A8, the termination control switches 14 are switched, and the termination setting of the device log transmission TCM is released and the process is ended.

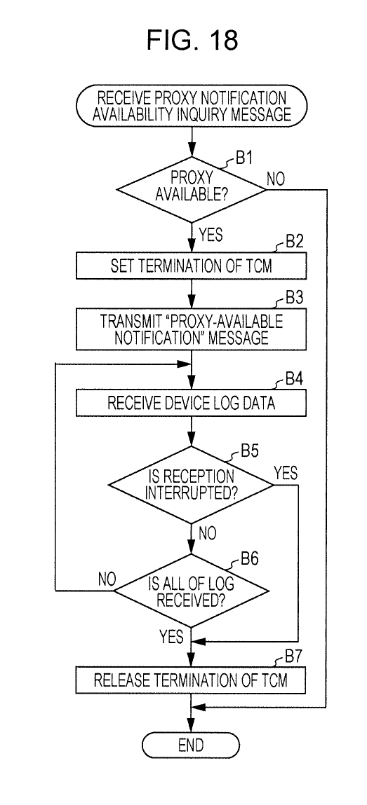

Next, a process of the proxy node 10 in the transmission system 1 as an example of the embodiment will be described according to a flowchart (steps B1 to B7) illustrated in FIG. 18.

In the node 10 which receives a proxy notification availability inquiry message from the failure node 10, the proxy-available determination section 27 determines whether or not the own node 10 can become the proxy node 10 (step B1).

In a case where the proxy-available determination section 27 determines that the own node 10 does not become the proxy node 10 (see NO route in step B1), the process is ended.

In a case where the proxy-available determination section 27 determines that the own node 10 becomes the proxy node 10 (see YES route in step B1), the process is moved to step B2.

In step B2, the termination control switches 14 are switched, and the termination setting of TCM to which the proxy notification availability inquiry message is transmitted is performed. Accordingly, the TCM becomes a device log transmission TCM.

In step B3, the proxy-available determination section 27 transmits the proxy-available notification message to the node 10 (the failure node 10) of a source address of the proxy notification availability inquiry message via the device log transmission TCM.

In step B4, the proxy node 10 receives the device log transmitted from the failure node 10.

In step B5, it is checked whether or not the log transmission interruption controller 23 interrupts the transmission.

In a case where transmission is not interrupted (see NO route in step B5), the process is moved to step B6. In step B6, it is checked whether or not all of data in the device log (the divided device log) is received.

In a case where all of data in the device log (the divided device log) is not received (see NO route in step B6), the process is returned to step B4.

In a case where all of data in the device log (the divided device log) is received (see YES route in step B6), the process is moved to step B7. In addition, as a result of checking in step B5, even in a case where the log transmission interruption controller 23 interrupts transmission of the device log (see YES route in step B5), the process is moved to step B7.

In step B7, the termination control switches 14 are switched, and the termination setting of the device log transmission TCM is released and the process is ended.

Next, a process in the transmission system 1 as an example of the embodiment described above will be described according to three cases.

Case 1

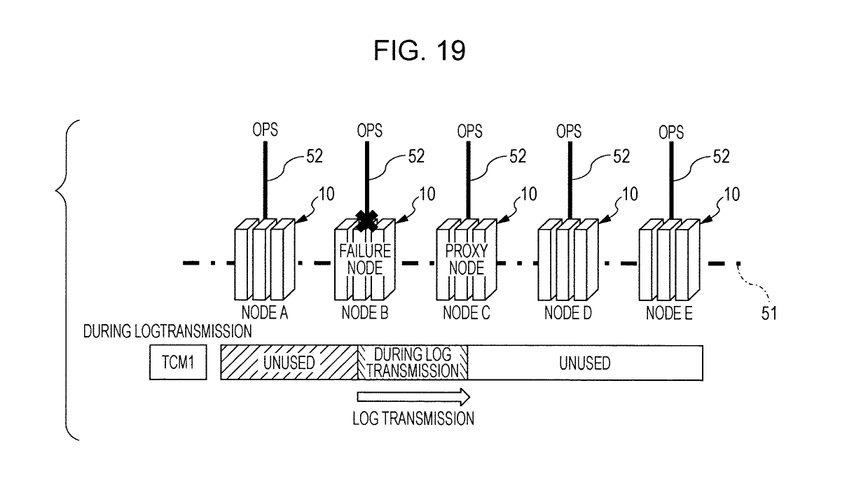

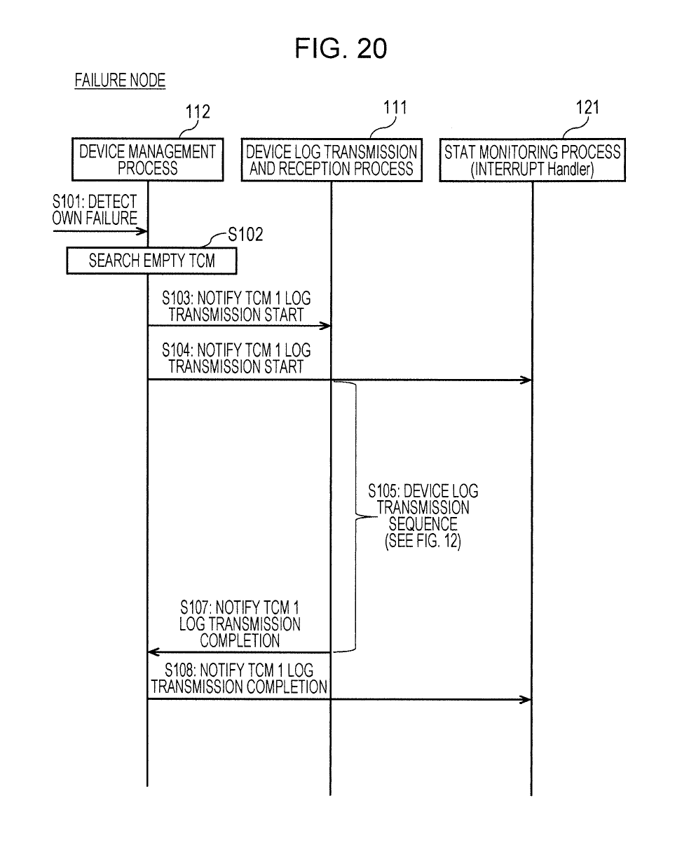

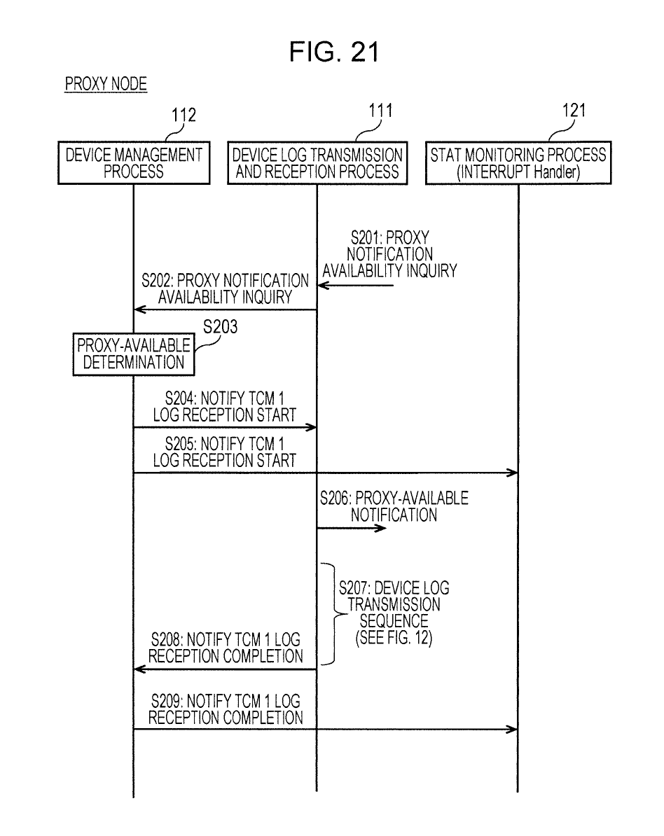

First, as the case 1, a process, in which the failure node 10 transmits the device log to the proxy node 10 adjacent to the failure node 10 in the transmission system 1 as an example of the embodiment, will be described with reference to FIG. 19 according to a sequence diagram illustrated in FIGS. 20 and 21.

FIG. 19 is an image diagram of a process in which the failure node 10 transmits the device log to the proxy node 10 adjacent to the failure node 10. In the example illustrated in FIG. 19, the node B is the failure node 10, the node C disposed to be adjacent to the node B is the proxy node 10, and the TCM 1 transmits the device log as a device log transmission TCM.

Further, FIG. 20 illustrates a process in the failure node 10, and FIG. 21 illustrates a process in the proxy node 10.

In a case where the node 10 (the node C in the example illustrated in FIG. 19) adjacent to the failure node 10 (the node B in the example illustrated in FIG. 19) is normally coupled to the OPS 50, the node C, which is the adjacent node 10, performs transmission of the device log as the proxy node 10.

As illustrated in FIG. 20, when failure occurs in the failure node 10, the device management process 112 (the failure detection section 25) detects occurrence of the failure (see symbol S101 in FIG. 20). The device management process 112 (the empty TCM searching section 26) searches for an empty TCM (see symbol S102 in FIG. 20). As a result of searching, the empty TCM searching section 26 determines that the TCM 1 is the empty TCM.

The device management process 112 (the first log transmission section 22) notifies the device log transmission and reception process 111 of a start of transmitting the device log using the TCM 1 (see symbol S103 in FIG. 20).

In addition, the device log transmission and reception process 111 (the first log transmission section 22) notifies the STAT monitoring process 121 of a start of transmitting the device log using the TCM 1 (see symbol S104 in FIG. 20). Accordingly, the STAT monitoring process 121 starts to monitor STAT of the device log transmission TCM used for device log transmission.

The device log transmission and reception process 111 (the first log transmission section 22) transmits the device log to the proxy node 10 (see symbol S105 in FIG. 20). Details of the device log transmission to the proxy node 10 are referred to FIG. 12.

When the transmission of the device log is completed, the device log transmission and reception process 111 (the first log transmission section 22) notifies (notifies TCM 1 log transmission completion) the device management process 112 of device log data transmission completion in the TCM 1 (see symbol S107 in FIG. 20).

The device management process 112 (the first log transmission section 22) notifies (notifies TCM 1 log transmission completion) the STAT monitoring process 121 of the device log transmission completion in the TCM 1 (see symbol S108 in FIG. 20).

On the other hand, as illustrated in FIG. 21, in the proxy node 10, the device log transmission and reception process 111 receives a proxy notification availability inquiry message (see symbol S201 in FIG. 21). The proxy notification availability inquiry message is transmitted from the device log transmission and reception process 111 (the proxy node searching section 21) of the failure node 10 to each of the nodes 10 (see symbol S1 in FIG. 12).

The device log transmission and reception process 111 transmits the proxy notification availability inquiry message to the device management process 112 (the proxy-available determination section 27) (symbol S202 in FIG. 21). The proxy-available determination section 27 determines (performs the proxy-available determination function) whether or not the own node 10 can be the proxy node 10 (symbol S203 in FIG. 21).

When the proxy-available determination section 27 determines that the own node 10 can become the proxy node 10, the device management process 112 notifies (performs a TCM 1 log receiving start notification) the device log transmission and reception process 111 of a start of receiving the device log by the TCM 1 (symbol S204 in FIG. 21).

In addition, the device management process 112 also notifies (performs the TCM 1 log receiving start notification) the STAT monitoring process 121 of the start of receiving the device log by the TCM 1 (see symbol S205 in FIG. 21).

The device log transmission and reception process 111 transmits a proxy-available notification message to the failure node 10 (see symbol S206 in FIG. 21).

The device log transmission and reception process 111 receives the device log from the failure node 10 (see symbol S207 in FIG. 21). Details of the device log transmission from the failure node 10 are referred to FIG. 12.

When the reception of the device log is completed, the device log transmission and reception process 111 notifies (notifies TCM 1 log reception completion) the device management process 112 of device log data reception completion in the TCM 1 (see symbol S208 in FIG. 21).

The device management process 112 notifies (notifies the TCM 1 log reception completion) the STAT monitoring process 121 of the device log reception completion in the TCM 1 (see symbol S209 in FIG. 21).

Case 2

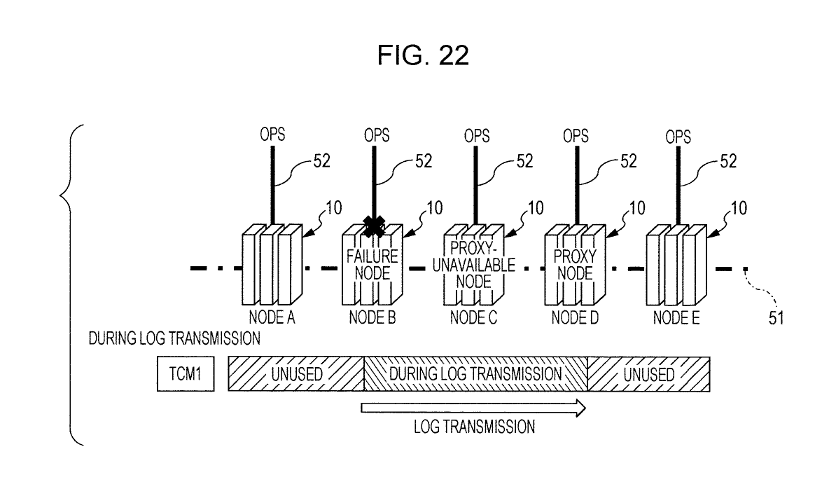

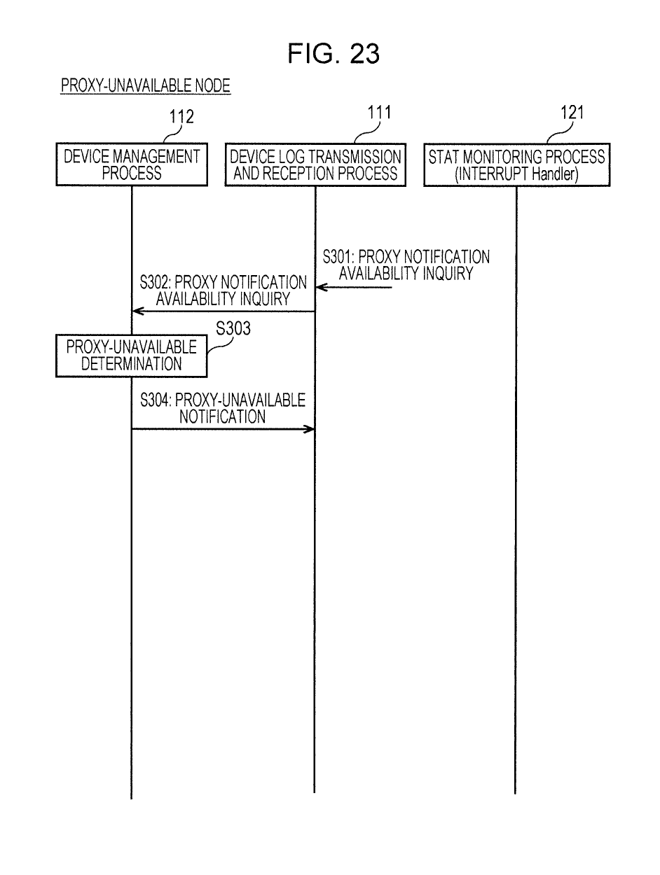

As the case 2, a process in a case where the node 10 adjacent to the failure node 10 may not become the proxy node 10 in the transmission system 1 as an example of the embodiment, will be described with reference to FIG. 22 according to a sequence diagram illustrated in FIG. 23.

FIG. 22 is an image diagram of a process in the case where the node 10 adjacent to the failure node 10 may not become the proxy node 10. In addition, FIG. 23 is a sequence diagram illustrating a process of the node 10 which is a proxy-unavailable node.

In the present example, a process in the failure node 10 is the same as the sequence diagram illustrated in FIG. 20, and description of the process will be omitted.

In the example illustrated in FIG. 22, the node B is the failure node 10, and the node C (adjacent node) disposed to be adjacent to the node B is a proxy-unavailable node of notification to the OPS 50. Hereinafter, there is a case where the node 10, which does not become the proxy node 10, is referred to as a proxy-unavailable node 10.

In a case where the own node 10 is not coupled to the OPS 50 or the own node 10 fails, the node 10 may not become the proxy node 10. The proxy-unavailable node 10 passes a proxy notification availability inquiry message from the failure node 10.

On the OTN 51, if there is a proxy-available node 10 before that, the node 10 (the node D in the example illustrated in FIG. 22) responses to the proxy-available notification message and transmits the device log from the failure node 10 (the node B in the example illustrated in FIG. 22) to the node D.

Even when the proxy notification availability inquiry message is transmitted from the failure node 10, it is also considered a case where there is no proxy-available node 10 and any of the nodes 10 does not response to the proxy notification availability inquiry message. For this reason, it is desirable to provide a timeout in the proxy notification availability inquiry message. After the timeout, it is desirable that the empty TCM searching section 26 restart to search for the empty TCM.

As illustrated in FIG. 23, in the proxy node 10, the device log transmission and reception process 111 receives the proxy notification availability inquiry message (see symbol S301 in FIG. 23). The proxy notification availability inquiry message is transmitted from the device log transmission and reception process 111 (the proxy node searching section 21) of the failure node 10 to each of the nodes 10 (see symbol S1 in FIG. 12).

The device log transmission and reception process 111 transmits the proxy notification availability inquiry message to the device management process 112 (the proxy-available determination section 27) (see symbol S302 in FIG. 23). The proxy-available determination section 27 determines (performs the proxy-available determination function) whether or not the own node 10 can be the proxy node 10 (see symbol S303 in FIG. 23).

When the proxy-available determination section 27 determines that the own node 10 may not become the proxy node 10, the device management process 112 notifies (performs a proxy-unavailable notification) the device log transmission and reception process 111 that the own node 10 is proxy-unavailable (see symbol S304 in FIG. 23).

In the node 10, in which it is determined that the own node 10 may not perform a proxy of the failure node 10, the termination control switches 14 do not switched. Accordingly, a frame flowing during a period assigned to the TCM 1 of the OTN 51 passes the node 10 which is determined to be proxy-unavailable.

Case 3

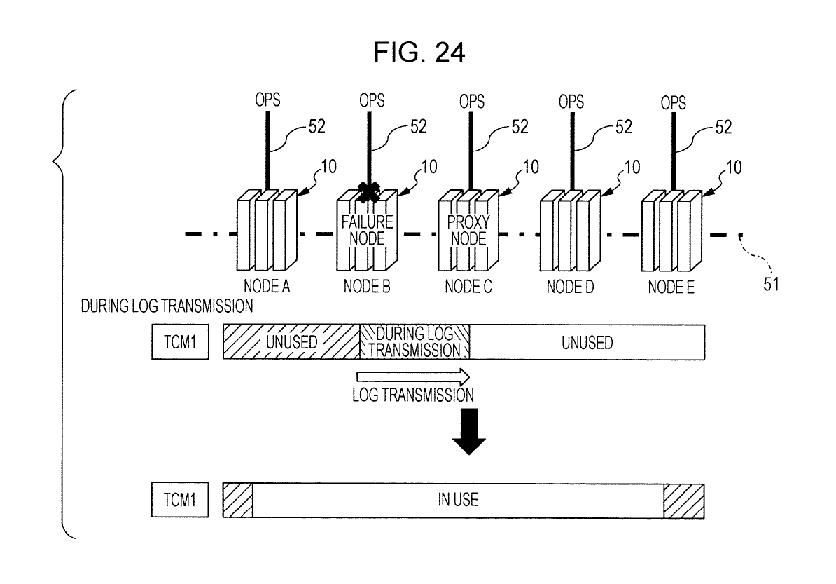

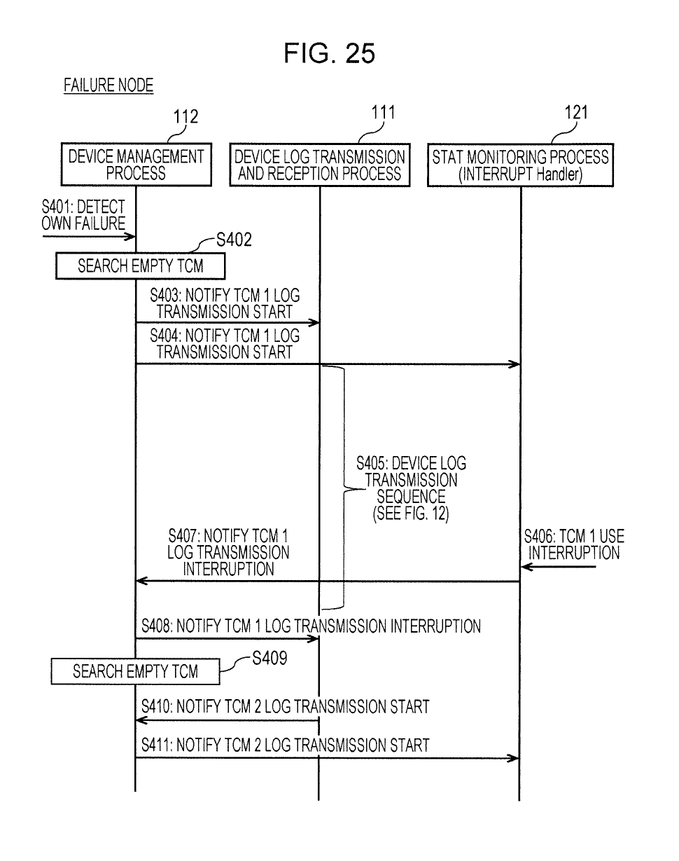

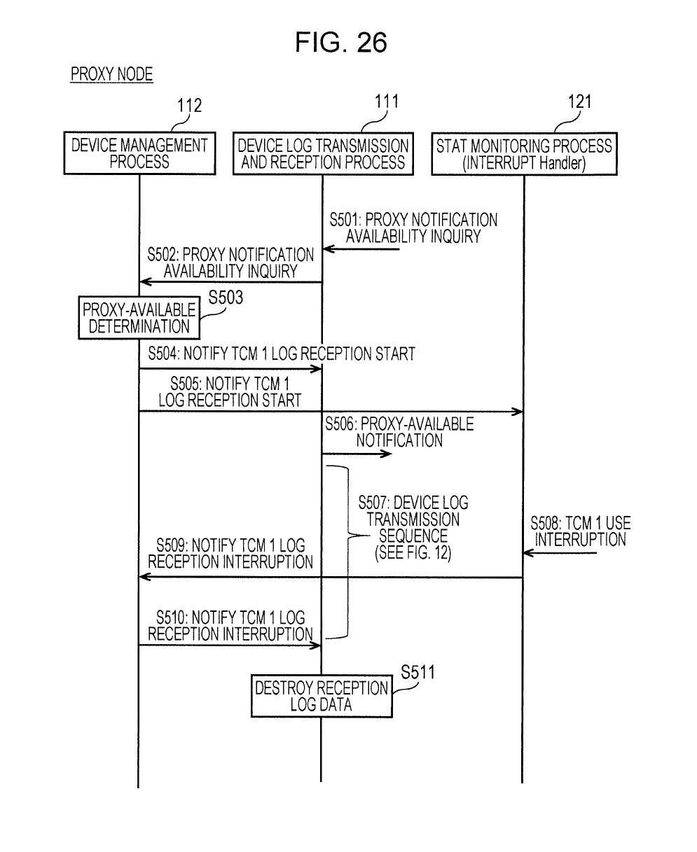

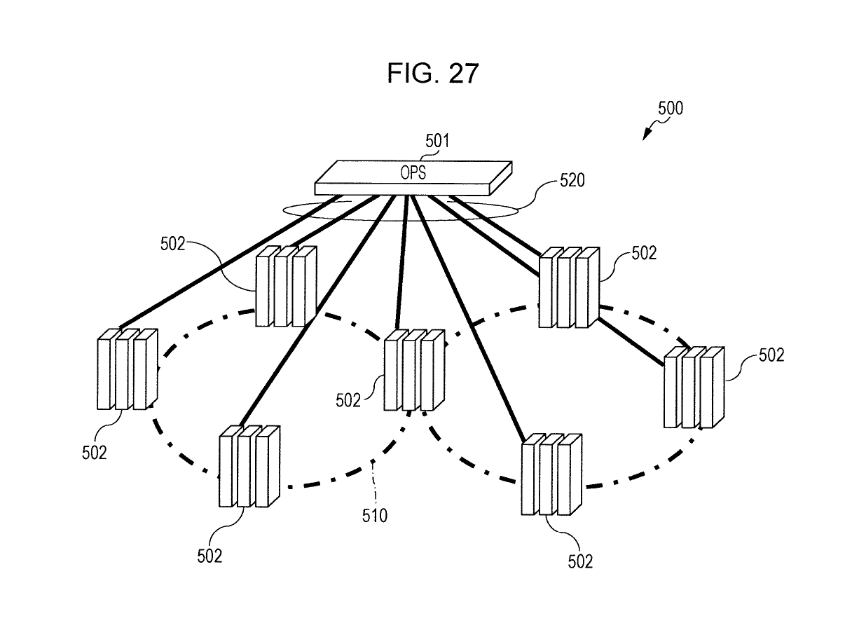

Next, as the case 3, a process in a case where transmission of the device log is interrupted during the transmission of the device log from the failure node 10 to the proxy node 10 in the transmission system 1 as an example of the embodiment, will be described with reference to FIG. 24 according to a sequence diagram illustrated in FIGS. 25 and 26.

FIG. 24 is an image diagram of a process in which an interruption occurs during the device log is transmitted from the failure node 10 to the proxy node 10. In the example illustrated in FIG. 24, the node B is the failure node 10, the node C disposed to be adjacent to the node B is the proxy node 10, and the TCM 1 transmits the device log as a device log transmission TCM.

In the present example, a case where the OPS 50 sets the TCM 1 to be used between the nodes (the node A and the node E in the example illustrated in FIG. 24) across the log transmission nodes (the node B and the node C in the example illustrated in FIG. 24) during the log transmission by TCM 1, will be described.

Before transmission of the device log using the TCM 1, that which TCM is used for the transmission of the device log is notified in advance to the STAT monitoring process 121 which monitors whether TCM is used or unused.

When it is checked that the device log transmission TCM is set to be used, the STAT monitoring process 121 notifies the device management process 112 (the first log transmission section 22) of an interruption of the log transmission so as to interrupt the log transmission.

The proxy node 10 deletes the log data of the device during reception, and the failure node 10 causes the empty TCM searching section 26 to re-search for an empty TCM. When there is the empty TCM, the TCM having an empty area is used as the empty TCM to transmit the log.

As illustrated in FIG. 25, when failure occurs in the failure node 10, the device management process 112 (the failure detection section 25) detects occurrence of the failure (see symbol S401 in FIG. 25). The device management process 112 (the empty TCM searching section 26) searches for an empty TCM (see symbol S402 in FIG. 25). As a result of searching, the empty TCM searching section 26 determines that the TCM 1 is the empty TCM.

The device management process 112 (the first log transmission section 22) notifies the device log transmission and reception process 111 of a start of transmitting the device log using the TCM 1 (see symbol S403 in FIG. 25).

In addition, the device management process 112 notifies the STAT monitoring process 121 of a start of transmitting the device log using the TCM 1 (see symbol S404 in FIG. 25). Accordingly, the STAT monitoring process 121 starts to monitor STAT of the device log transmission TCM used for device log transmission.

The device log transmission and reception process 111 (the first log transmission section 22) transmits the device log to the proxy node 10 (see symbol S405 in FIG. 25). Details of the device log transmission to the proxy node 10 are referred to FIG. 12.

During the transmission of the log using the TCM 1, an interruption (TCM 1 use interruption) indicating that the TCM 1 is used for communication with another node 10 is input to the STAT monitoring process 121 (see symbol S406 in FIG. 25).

The STAT monitoring process 121 (the log transmission interruption controller 23) transmits a transmission interruption notification to the device management process 112 (see symbol S407 in FIG. 25). Accordingly, the transmission of the device log from the failure node 10 to the proxy node 10 is interrupted. The device management process 112 (the first log transmission section 22) notifies the device log transmission and reception process 111 of an interruption of transmitting the device log using the TCM 1 (see symbol S408 in FIG. 25).

In the failure node 10, the device management process 112 (the empty TCM searching section 26) searches for an empty TCM (see symbol S409 in FIG. 25). As a result of searching, the empty TCM searching section 26 selects, for example, the TCM 2 as the empty TCM.

The device log transmission and reception process 111 notifies the device management process 112 (the first log transmission section 22) of a start of transmitting the device log using the TCM 2 (see symbol S410 in FIG. 25).

In addition, the device management process 112 notifies the STAT monitoring process 121 of a start of transmitting the device log using the TCM 2 (see symbol S411 in FIG. 25). Accordingly, the transmission of the device log from the interrupted failure node 10 is restarted.

On the other hand, as illustrated in FIG. 26, in the proxy node 10, the device log transmission and reception process 111 receives a proxy notification availability inquiry message (see symbol S501 in FIG. 26). The proxy notification availability inquiry message is transmitted from the device log transmission and reception process 111 (the proxy node searching section 21) of the failure node 10 to each of the nodes 10 (see symbol S1 in FIG. 12).

The device log transmission and reception process 111 transmits the proxy notification availability inquiry message to the device management process 112 (the proxy-available determination section 27) (see symbol S502 in FIG. 26). The proxy-available determination section 27 determines (performs the proxy-available determination function) whether or not the own node 10 can be the proxy node 10 (see symbol S503 in FIG. 26).

When the proxy-available determination section 27 determines that the own node 10 can become the proxy node 10, the device management process 112 notifies (performs a TCM 1 log receiving start notification) the device log transmission and reception process 111 of a start of receiving the device log by the TCM 1 (see symbol S504 in FIG. 26).

In addition, the device management process 112 also notifies (performs the TCM 1 log receiving start notification) the STAT monitoring process 121 of the start of receiving the device log by the TCM 1 (see symbol S505 in FIG. 26).

The device log transmission and reception process 111 transmits a proxy-available notification to the failure node 10 (see symbol S506 in FIG. 26).

The device log transmission and reception process 111 receives the device log from the failure node 10 (see symbol S507 in FIG. 26). Details of the device log transmission from the failure node 10 are referred to FIG. 12.

During the transmission of the log using the TCM 1, an interruption (TCM 1 use interruption) indicating that the TCM 1 is used for communication with another node 10 is input to the STAT monitoring process 121 (see symbol S508 in FIG. 26).

The STAT monitoring process 121 (the log transmission interruption controller 23) inputs a notification of interrupting the reception of the device log (reception interruption notification) to the device management process 112 (see symbol S509 in FIG. 26).

The device management process 112 inputs a notification (the TCM 1 reception interruption notification) of interrupting the reception of the device log using the TCM 1 to the device log transmission and reception process 111 (see symbol S510 in FIG. 26). Accordingly, the reception of the device log in the proxy node 10 is interrupted.

The device log transmission and reception process 111 deletes the received device log (see symbol S511 in FIG. 26), and ends the process.

C. Effect

In this way, according to the transmission system 1 as an example of the embodiment, the first log transmission section 22 of the failure node 10, in which communication with the OPS 50 is failed, transmits a device log of the own node 10 (the failure node 10) to the proxy node 10. Then, the second log transmission section 24 of the proxy node 10 which receives the device log transmits the device log of the failure node 10 to the external server 60 via the control monitoring network 52.

Accordingly, in a case where communication failure occurs with the OPS 50 in the failure node 10, the device log of the failure node 10 can be transmitted to the external server 60 via the proxy node 10. In the external server 60, by analyzing the device log of the failure node 10, it is possible to quickly restore the failure and improve reliability of the system. In addition, it is possible to improve maintenance efficiency.

The proxy node searching section 21 transmits the proxy notification availability inquiry message to another node 10 using the empty TCM searched by the empty TCM searching section 26 to search for the proxy node 10.

Accordingly, in general, it is possible to effectively utilize TCM which is used infrequently in a system operation phase.

In failure node 10 in which communication failure with the OPS 50 occurs, the empty TCM searching section 26 searches for an empty TCM which is not used in the OTN 51, and transmits and receives various messages or the device log using the empty TCM. Accordingly, it is possible to transmit and receive the device log between the nodes 10 without adversely affecting the OPS 50 or the like.

In the node 10 which receives the proxy notification availability inquiry message, in a case where the proxy-available determination section 27 determines that the own node 10 can become the proxy node 10, the node 10 becomes the proxy node 10 and the proxy-available notification message is transmitted to the failure node 10 using the empty TCM. Accordingly, without providing a control device which centrally controls monitoring each of the nodes 10, appointment of the proxy node 10, collection of the device log of the failure node 10, and transmission to the external server 60, it is possible to autonomously transmit the device log of the failure node 10 between the transmission devices 10 included in the transmission system 1 to the external server 60.

D. Others

Further, the present disclosure is not limited to the embodiments described above, and various modifications can be made without departing from the spirit of the present disclosure.

For example, in the embodiment described above, various messages or the device log are transmitted and received using TCM, but the embodiment is not limited thereto. Instead of the TCM, SM or PM may be used, and various modifications can be used.

In addition, by the disclosure described above, the present embodiment can be implemented and manufactured by those skilled in the art.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network system comprising:
a plurality of transmission devices configured to be coupled to each other via a first network; and
a control monitor configured to be coupled to each of the plurality of transmission devices via a second network,
wherein a first transmission device including a first transmitter, among the plurality of transmission devices includes a first processor configured to search for a signal area that is empty for checking connectivity in the first network, and to transmit, with the first transmitter, log information to a second transmission device that includes a second transmitter and a second processor among the plurality of transmission devices via the signal area in the first network when abnormality is detected in communication with the control monitor, and
the second processor is configured to transmit, with the second transmitter, the transmitted log information to the control monitor via the second network.

2. The network system according to claim 1,
wherein the first processor is configured to search for a proxy transmission device which transmits the log information to the control monitor instead of the first transmission device, among the plurality of transmission devices.

3. The network system according to claim 2,
wherein the first processor is configured to transmit a proxy-notification-availability inquiry message to transmission devices other than the first transmission device among the plurality of transmission devices via the first network.

4. The network system according to claim 1,
wherein the first processor is configured to monitor a use state of the signal area, and
in a case of detecting that the signal area is used, transmission of the log information is interrupted by the first processor.

5. A transmission device among a plurality of transmission devices coupled to each other via a first network, the transmission device comprising:
a processor,
wherein the processor is configured to:
search for a signal area that is empty for checking connectivity in the first network, and
transmit, with the first transmitter, log information to another transmission device among the plurality of transmission devices via the signal area that is the empty in the first network when abnormality is detected in communication with a control monitor coupled via a second network.

6. The transmission device according to claim 5,
wherein the processor is configured to search for a proxy transmission device which transmits the log information to the control monitor instead of the transmission device, among the plurality of transmission devices.

7. The transmission device according to claim 6,
wherein the processor is configured to transmit a proxy-notification-availability inquiry message to the another transmission device via the first network.

8. The transmission device according to claim 5,
wherein the processor is configured to monitor a use state of the signal area, and in a case of detecting that the signal area is used, transmission of the log information is interrupted by the processor.

9. A non-transitory, computer-readable recording medium having stored therein a program for causing a computer, included in a transmission device among a plurality of transmission devices coupled to each other via a first network, to execute a process, the process comprising:
searching an empty signal area for checking connectivity in the first network, and
transmitting, with a transmitter, log information to another transmission device among the plurality of transmission devices via the empty signal area in the first network when abnormality is detected in communication with a control monitor coupled via a second network.

10. The computer-readable recording medium according to claim 9, the process further comprising:
searching a proxy transmission device which transmits the log information to the control monitor instead of the transmission device, among the plurality of transmission devices.

11. The computer-readable recording medium according to claim 10, which causes the computer to execute a process, the process further comprising:
transmitting a proxy-notification-availability inquiry message to the other transmission device via the first network.

12. The computer-readable recording medium storing the program according to claim 9, which causes the computer to execute a process, the process further comprising:
monitoring a use state of the signal area, and
interrupting the transmission of the log information in a case of detecting that the signal area is used.

13. A transmission device which is coupled to other transmission devices via a first network and coupled to a control monitor via a second network, the transmission device comprising:
a computer,
wherein the computer is configured to transmit, with a transmitter, log information transmitted from another transmission device among the other transmission devices via a signal area for checking connectivity in the first network to the control monitor via the second network when abnormality is detected in communication with the control monitor in the another transmission device.
